(19) United States
(12) Patent Application Publication
(10) Pub. No.: US 2012/0196257 A1
(43) Pub. Date: Aug. 2, 2012

(54) COGNITIVE FUNCTION TRAINING TO IMPROVE MOTOR ABILITY

(76) Inventors: Joe Verghese, Bronx, NY (US); Roee Holtzer, Teaneck, NJ (US)

(21) Appl. No.: 13/389,871

(22) PCT Filed: Jul. 7, 2010
(86) PCT No.: PCT/US10/01913

§ 371 Date: Apr. 9, 2012

Related U.S. Application Data
(60) Provisional application No. 61/275,290, filed on Aug. 27, 2009.

(51) Int. Cl. G09B 19/00

(52) U.S. Cl. 434/255

(57) ABSTRACT

Disclosed are methods of improving motor functions of a subject by administering cognitive function training to the subject. The cognitive functions trained can include executive and/or attention functions. The improved motor functions can be, for example, one or more of improved gait, increased speed of walking, increased speed of walking while talking, and decreased incidence of falling.

### CROSS-REFERENCE TO RELATED APPLICATION

This application claims priority of U.S. Provisional Patent Application No. 61/275,290, filed on Aug. 27, 2009, the content of which is incorporated by reference.

### BACKGROUND OF THE INVENTION

Throughout this application various publications are referred to in superscripts. Full citations for these references may be found at the end of the specification immediately preceding the claims. The disclosures of these publications are hereby incorporated by reference in their entireties into the subject application to more fully describe the art to which the subject application pertains.

An estimated 54 million persons or nearly 20% of the U.S. population have mobility disabilities or limited motor function. Older Americans report an even higher mobility disability rate of nearly 37%. Though recent reports suggest a decline in mobility disability generally, the absolute number of affected seniors will remain high given increasing life expectancy and rising conditions such as obesity.

Generally, people with mobility disabilities are less likely to live in the community, have worse quality of life, and higher mortality rates. People with mobility disability have more falls, more days of pain, and experience a poorer quality of life than those without activity limitations. Thus, addressing mobility disabilities are important both to the individual and to the greater community in which they live.

The process of disablement has been described as having four interrelated components: pathology, functional impairments, functional limitations, and disability. Pathology refers to disease or injury. Functional impairments are dysfunctions in bodily systems. Functional limitations are restrictions in activities of daily living (ADL). The ultimate result of the disablement process is disability which can be signaled by, for example, an inability to perform ADL. Thus, the disablement process is an evolving continuum leading from pathology to functional impairments (e.g., slow gait), on to functional limitations (e.g., inability to climb stairs), and ultimately disability.

The disablement process can be exacerbated when an individual has a sedentary lifestyle. A sedentary lifestyle is considered a significant risk factor leading to disablement. Seniors are a high risk group for disability, and not surprisingly also tend to live a much more sedentary lifestyle than younger individuals.

Mobility disability in older adults is often defined by walking ability. That is, the ability to walk is an index of health and functional status in older adults. Walking is important for participation in neighborhood activities such as shopping, clinic visits, or visiting friends and relatives. Mobility disability can be identified in many ways including self-report by the individual. However, quantification of mobility disability is often undertaken by observing walking speed, the inability to walk a fixed distance, measuring the distance walked in a fixed time, and other known parameters.

Physical exercise (PE) is known to be effective in preventing mobility disability, but compliance, particularly among seniors, is low. Many PE intervention studies ranging in duration from 8 to 12 weeks have reported beneficial effects on gait in frail seniors.¹⁻⁷ In most of these studies, improvement in velocity varied from 7 to 12 cm/sec. In contrast, the non-intervention controls in these studies have shown minimal improvement and either no change or a decline in velocity (up to 8 cm/sec) over the same time. The 1994 Fiatarone study⁵ reported on a randomized clinical trial (RCT) that compared resistance exercises and nutrient supplementation in 100 frail but ambulatory seniors (mean age 87) over 10 weeks. Of the 94% of the subjects who completed the study, walking speed increased by 11.8±3.8% in exercisers but declined by 1.0±3.8% in non-exercisers. In the 2002 Timonen study, 68 frail women (mean age 83 years) were randomized to either supervised PE or home based exercise for 10 weeks. Again, gait velocity was better improved in the PE group (12 vs. 5 cm/sec).

Despite these promising results and widely reported benefits in both scientific and popular media, exercise participation is low among seniors.^{9,10} Adherence is low among those starting PE; 50% of individuals joining PE programs drop out in the first 3-6 months. Even in RCTs, compliance with PE among seniors is low with attrition in the first year ranging from 22 to 76%. ¹⁰ Further complicating matters, while seniors as a demographic group bear a large burden of mobility disabilities and the diseases amenable to prevention and treatment with PE, they often have the least access and opportunity for PE.

The correlation between PE or physical exertion and improved mobility/motor function is not unexpected since the training directly impacts the domain for which improvement is sought. Correlations between motor function and other processes have also been observed. For example, older adults with better attention and executive function generally have better mobility and exhibit greater gait velocity or walking speed.¹² Conversely, impairments in attention and executive function are increasingly associated with impaired gait and falls.^{13-14, 44}

Executive function refers to a variety of higher cognitive processes that use and modify information from many cortical sensory systems in the anterior and posterior brain regions to modulate and produce behavior.⁴⁴ Attention is considered a specific example of executive function.⁴⁴ Cognitive processes include a wide variety of additional domains including processing speed, hand eye coordination, memory, naming, and others.

Exposure to enriched environments has been associated with improved motor function in primate models of focal brain injury.¹⁶ In seniors, cognitive training has shown improvement in cognition and functions such as ADL and driving skills.¹⁷ Dual task training, incorporating cognitive exercises with PE, has been reported to improve normal gait velocity in stroke patients.^{18,19} This finding is unsurprising as PE is know to improve walking speed. In addition, pharmacological interventions targeting attention and executive processes have also shown some improvement in gait velocity.²⁰⁻²⁴

Another avenue of study has been the use of computer based Cognitive Remediation (CR).²⁵⁻³⁵ These studies have shown that computer based CR can lead to persistent effects on attention and executive functions. The Ball study²⁵ reported that 10 one-hour attention training sessions were associated with cognitive improvements in processing speed (68% improvement) and reasoning (49% improvement) up to two years later without additional training or boosters. The results from computerized CR studies demonstrate that unlike PE, computerized CR is feasible in older adults, including those that are frail or cognitively impaired.

Each of the known methods of increasing mobility (i.e., PE and pharmacological regimens) have shortcomings. For example while PE is recommended to prevent mobility disability, compliance among seniors is low. Further, medical concerns may limit the applicability of pharmacological interventions, particularly for individuals already taken one or more prescription drugs. Thus, new treatment options are needed as an alternative or supplemental strategy for seniors who do not engage in one of the existing treatment methods due to physical, medical, motivational, or socioeconomic reasons.

### SUMMARY OF THE INVENTION

The present invention is directed to cognitive remediation targeting attention and executive function as a strategy to improve mobility, particularly in seniors. The invention provides methods of improving motor function of a subject, comprising administering cognitive function training to the subject in an amount and manner effective to improve mobility in the subject.

### BRIEF DESCRIPTION OF THE DRAWINGS

FIG. 1 depicts the results of a study of gait velocity for both normal walking and Walking While Talking (WWT).

FIG. 2 depicts both the pre and post CR scores on an Attention Network Test.

### DETAILED DESCRIPTION OF THE INVENTION

The invention provides a method of improving motor function of a subject comprising administering cognitive function training to the subject in an amount and manner effective to improve mobility in the subject.

The motor function that is improved can include one or more of improved gait parameters, increased speed of walking, increased speed of walking while talking, decreased incidence of falling, improved stair climbing and improvement in one or more different modes of progression including walking, skipping, hopping or running, among others.

The cognitive functions trained include executive function and/or attention.

Improved mobility in the subject can be measured according to any number of standard methods. Preferred methods of measuring mobility include measuring walking speed, or speed of walking while talking. Gait velocity or walking speed can be monitored for example on an instrumented walkway. One example of an instrumented walkway is the GAITRite walkway manufactured by CIR Systems, Inc., Havertown, Pa. The instrumented walkway utilizes embedded sensors to measure “normal walking speed” of the subject. Additionally, other gait parameters may be measured including pace, rhythm, variability, and others.

The walking while talking (WWT) test provides a valid test of mobility in older adults. The WWT test is a divided attention task that has shown the ability to predict falls in seniors.³⁶ Findings suggest that the WWT measure is responsive to physical and cognitive interventions, and improvements in WWT is accompanied by those in mobility.³⁷

One form of the WWT test asks seniors to walk an instrumented walkway for two trials while reciting alternate letters of the alphabet. In addition to gait parameters, number of errors while reciting letters and number of correct alphabets are also recorded. Subjects are given practice trials as required. The order of the initial letter on WWT can also be randomly varied between ‘A’ and ‘B’ to minimize practice effects.

As an initial step in conducting the training process or method, a baseline set of parameters can be established for a subject's motor function or mobility and cognitive function. The motor function of the subject can be assessed prior to cognitive function training. Subsequently, the motor function of the subject can be assessed following cognitive function training, and compared to motor function prior to cognitive function training to assess the improvement in motor function. Following the training, the subject can be tested to determine whether the subject has experienced an improvement in e.g. gait parameters, speed of walking, speed of walking while talking, and/or a decreased incidence of falling as compared to a similar testing undertaken prior to the training.

A test that can be used to establish a set of baseline values for later comparison in order to assess the effects of the cognitive training is the Attention Network Test (ANT). The ANT is a combination of cued reaction time (RT) and the flanker tasks.^{8,38} The ANT provides estimates of three separate attention networks of alerting, orienting, and executive attention. These networks have been linked to separate brain substrates and distinct genetic polymorphisms.³⁹⁻⁴³ The ANT is a computerized test that requires subjects to determine whether a central arrow points left or right. Efficiency of three attentional networks is assessed by measuring how response times are influenced by alerting cues, spatial cues, and flankers (i.e., congruent or incongruent conditions). The task is simple and reliable estimates of the 3 networks can be obtained within a half hour.

Cognitive training is often undertaken in the form of games or a series of relatively simple tasks that a subject must complete in a relatively short period of time. The practice of using games is detailed in U.S. Pat. No. 6,632,170⁴⁵ assigned to Cognifit LTD, Israel, which is incorporated herein by reference. With respect to various types of attention and executive function training, U.S. Pat. No. 6,632,174 describes a number of attention games including:

Divided attention (between modalities)—A picture of an object may be presented simultaneously with a sound of a name of the same or of another object. The user indicates whether or not the visual and the auditory stimuli represent the same object. The time taken for a correct answer may be measured and the results analyzed.

Selective attention—A yellow circle may be presented on the screen, which may be in a different place for each trial. The user may move the cursor to the circle and clicks on it. Several visual distractions may appear on the screen during the task. The user has to use selective attention in order to minimize the effect of the distractions. The user's responses may be recorded and analyzed.

Sustained attention—A moving yellow circle may be presented on the screen. The user may track its movement, with, for instance, a mouse cursor or a stylus, for a sustained period of time. The accuracy of this tracking may be recorded and analyzed. The point at which performance decline is detected determines the duration of efficient sustained attention.

With respect to executive training, U.S. Pat. No. 6,632,174 describes the following games:

Speed of decision—Almost all of the tasks may involve a speed-of-decision measure. For example, two objects may be presented on the screen moving at different speeds and approaching a common point from opposite directions. The screen may then be “frozen”, and the user may indicate whether or not the first object, for example, would have had time to reach the common point and turn left before the second object arrived at the common point. The time between the “freezing” of the picture and the beginning of the response determines the decision speed.

Inhibition skills—A circle may be presented on the screen. The user may move the mouse cursor on the circle and click only when, for example, the circle color is yellow. Sometimes the color of the circle may change as the cursor approaches the circle, and the user may attempt to inhibit his or her response.

Route planning—Displayed on the screen may be, for example, a yellow circle, a bell, and various other objects moving across the screen. Using the mouse cursor, the user may bring the yellow circle to the bell (the target) without hitting any of the moving objects. With each task, the bell may move to a new location on the screen. In order to do the task quickly and without errors, the user may dynamically plan the route of movement.

Discrimination efficiency—Two circles of different size may be presented on the screen. The user may choose the smaller one and click on it with the mouse cursor. The time from the introduction of the circle to the beginning of the cursor movement towards the small circle may be used to determine the discrimination time by comparing it to the time taken in a similar task when only one circle is presented.

It is noted that references in these example to color and/or shape are incidental, and any other color, shapes or appropriate stimuli could be interchanged with the mentioned stimuli and still be within the principles of the present invention. One of skill in the art will recognize that these cognitive training tasks are provided as examples, and other cognitive training tasks focusing on attention and executive function could be used without departing from the scope of the invention.

Though attention and executive function training can be undertaken without the use of a computerized cognitive training program, computerization provides a convenient method of undertaking the cognitive training employing the training described above. There are many currently available computer based cognitive training programs. In selecting a computer based cognitive training program, the program should have a user interface and programming utilizing advances in cognitive theory, such as the use of game theory to deliver the program in the form of games and other stimulating forms to the user. It is preferable that the cognitive training program have size and color adaptations that take into account the sensory capacities of older adults. The cognitive training program can provide training on a number of cognitive processes, but particularly those related to attention and executive function.

One such program is Mindfit™ produced by CogniFit, Inc.; however, other cognitive training programs, and computer based cognitive training programs, could also be used, as could non-computer based cognitive training techniques.

In one aspect of the invention, the cognitive training program may be individually constructed for a specific subject based upon a baseline cognitive evaluation. This evaluation may undertake a quantitative assessment of cognitive processes such as naming, psychomotor skills, digit and visual span, Stroop effect, sustained attention, and executive function. These tests have been reported to have good correlations with traditional cognitive tests and the Cambridge Neuropsychological Test Automated Battery.¹⁵

Based on distribution of cognitive test scores on the baseline evaluation, the subjects' cognitive abilities (compared to normative data) can be divided into three categories: abilities on which a subject performed well, abilities performed in the medium range of the norm, and abilities on which performance was low. A sample training session can be as follows. On the first day of training, for example, the subjects can train on a task reflecting his/her highest scoring ability in each category. On the second day of training, a new task reflecting his/her second highest scoring ability can be assigned from abilities on which the subject performed well. The tasks from the day before from the medium scoring abilities and the low scoring abilities can be used a second time. On a third day, a new task can be selected from the tasks reflecting his/her second highest scoring abilities from the medium scoring abilities and repeated practice is conducted with one of the familiar tasks in the other two categories. If a category of abilities has no new tasks, new tasks can be taken from another category with the next best ranking.

This form of practice allocation can continue for the length of the training program, so that every day a new task is introduced. The system should preferably have the ability to ensure that a subject always works in their comfort zone and always practices their better abilities before weaker. At the same time, if performance is low on a large number of abilities, the system should ensure that the subject will reach practice for his/her weakest cognitive abilities relatively late in the training program, thereby preventing high levels of frustration. Because each task has a few levels of difficulty, the subject can begin with the most elementary level, thereby further minimizing any subject frustration. The task allocation described ensures a subject is never allocated a training session which is similar to previous sessions, reducing boredom and fatigue.

Each training session can contain, for example, 3 tasks that take about 20 minutes total to complete. A task pool may be used for about 20 minutes of attention training after scheduled training is completed. Hence, total training time per day may be about 40 minutes. Over an 8 week regimen (24 days), for example, each subject can receive two complete cycles (24 sessions of scheduled training and 24 sessions of targeted attention and executive function training) of training.

Following completion of a cognitive training regime, for example 8-weeks or more, a cognitive evaluation similar to that utilized at the beginning of the program can be employed to assess changes in cognition. Further, the very same motor function tests, including measuring gait parameters, and walking speed, as well as the WWT test can be used to assess changes in motor function. Still further, the ANT could be administered after completion of the training regimen.

According to one aspect of the method, the cognitive training is undertaken three (or more) times weekly for about 40 minutes each day. Of the 40 minutes, about 20 minutes are executive function training and about 20 minutes are attention training. The training may take place for about 8 (or more) weeks. Shorter or longer durations both daily and for the training regimen may also be employed. Further, the cognitive training may become part of the subjects regular weekly routine. Still further, the cognitive training may be employed for a specific duration (e.g. 8 weeks) yearly or semi-yearly as needed to maintain an existing level of motor function.

The results of the gait and gait velocity testing as well as the WWT and ANT may be used by health care professionals and compared to regular assessments, for example yearly, to assess mobility as well as determine when further cognitive training may be beneficial to the subject.

Preferably, the invention is directed at seniors, that is subjects 65 years of age or older, or 70 years of age or older; however, the beneficial effects of cognitive training on mobility may be experienced by persons of any age. Further, while the subject may have a motor function disability before the onset of cognitive training, even subjects without a motor function disability may benefit from the training. Cognitive training can be undertaken at home by the subject.

Thus, in accordance with the present invention cognitive training, specifically that focusing on executive function and attention, can increase a subject's mobility as demonstrated, for example, by increased gait velocity even where the subject does not or cannot perform PE.

### Experimental Details

An experiment was performed to demonstrate the effectiveness of the present invention. To frame the findings in terms of a clearly understood and widely used reference measure and to facilitate comparisons, gait velocity during normal walking, measured quantitatively (using the GAITRite system), was chosen as the primary outcome for analysis. Gait velocity is recommended as a simple and practical screen of health and function in seniors. It is easier to perform than other measures that require more time, space, or equipment.

In the experiment 950 seniors were randomly selected from the Bronx county (New York) voter lists from zip codes neighboring the research center. 105 of the subjects in this list were <70 years, and 120 subjects were either deceased or without valid contact numbers. The remaining 715 subjects were sent letters and then called 3-4 days later. The tester explained the nature of the study, screened for memory impairment with the Telephone based Memory Impairment Screen (MIS-T) (excluded if score<5) and mobility impairment. 45 non-demented sedentary elderly with self-reported mobility impairments were identified by telephone and invited for further evaluation. Nine subjects could not come on the screening day due to prior commitments (but were agreeable to come at another date) and four cancelled (32 available). After obtaining written consent, 7 subjects who walked faster than 1 m/sec and one who scored <25 on Mini-Mental State Examination (MMSE) were excluded. Of the remaining 24 eligible subjects, 12 were randomized to the Cognitive Remediation (CR) arm and 12 to ‘usual care’ control. This sample was chosen based on the number needed in each cycle of the intervention.

There were no significant differences in demographic characteristics between CR and control subjects. While not significant, the CR subjects actually had worse mean scores on velocity during normal walking and on the Walking While Talking (WWT) test at entry. 50% met the Fried frailty criteria in both groups. As for an existing comfort level or experience with computers, only 2 out of the 24 subjects owned a personal computer.

TABLE 1
Baseline characteristics of Subjects

| | CR | Control | |
|---|---|---|---|
| | (n = 12) | (n = 12) | p-value |
| Age | 77.4 ± 7.0 | 79.9 ± 7.5 | 0.41 |
| Female, n | 8 | 7 | 0.70 |
| Frail (Fried criteria), n | 6 | 6 | 0.99 |
| Difficulty walking, n | 9 | 8 | 0.50 |
| Falls last 12 mo, n | 3 | 2 | 0.99 |
| MMSE scores | 29.0 ± 0.3 | 29.1 ± 0.4 | 0.87 |
| Gait velocity (normal) | 69.2 ± 18.7 | 74.7 ± 18.6 | 0.50 |
| WWT velocity | 36.1 ± 12.4 | 45.2 ± 20.1 | 0.29 |

The CR group received training for 24 sessions (40 minutes each), 3 days per week for 8 weeks. Make-up sessions were accommodated within the regular training schedule for this trial and did not require extra days. Study assessments were done at baseline and at end of the intervention at week 8. Interim assessments were not done to minimize practice effects.

The controls had the introductory physical fitness awareness work shop, were provided exercise brochures, list of exercise and health facilities in their neighborhoods, and had telephone contacts for the study staff. None of the subjects participated in any other intervention study or rehabilitation program during the study period. Post-intervention measurements at week 9 were reported in 10 CR and 10 control subjects who completed the study.

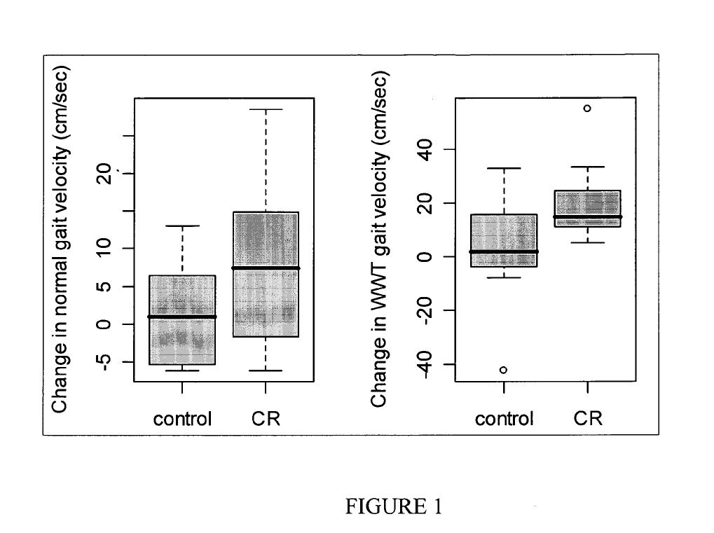

Subjects who received the 8-week CR program improved gait velocity on both normal walking (change: 8.2±11.4 vs. 1.3±6.8 cm/sec, p=0.19) as well as on WWT (change: 19.9±14.9 vs. 2.5 f 20.1 cm/sec, p=0.05) compared to usual care controls. One outlier in each group had changes on WWT in expected directions as shown in FIG. 1.

Six out of 10 CR group participants improved gait velocity 4 cm/sec or more (used for power estimates) on normal walking in 8 weeks compared to 3 out of 10 in the control group (unadjusted odds ratio 3.0, 95% CI 0.5 to 19.6). All 10 CR subjects showed ≧4 cm/sec improvement on WWT velocity compared to three out of 10 controls (unadjusted OR 3.5, 95% CI 1.5-8.0) (FIG. 1).

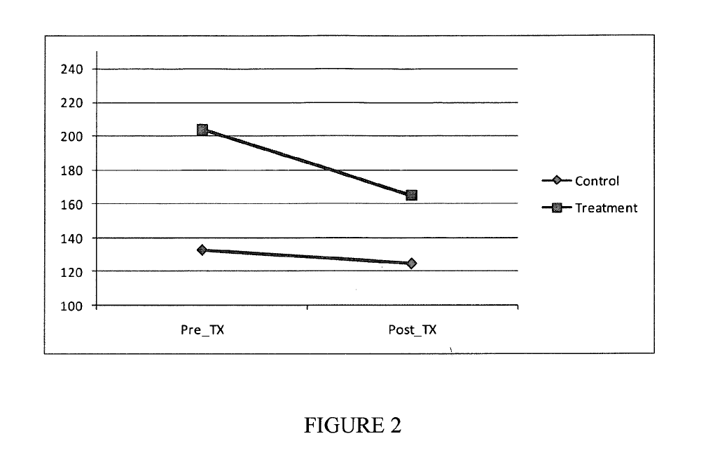

Subjects in the CR group also showed improvements on the executive attention scores on the Attention Network Test (ANT). The CR group had worse executive attention scores on ANT at baseline than controls. Nonetheless, the CR group improved (lower scores better) their executive attention network scores from baseline (203±143 ms) to post-intervention (164±99 ms; p=0.09). The controls, on the other hand, showed only minimal improvement (pre 132±43 vs. post 125±33 ms; p=0.44) (FIG. 2).

Three month follow-up: Nine subjects from each group returned for a follow-up assessment at 3 months post-intervention (5 months from baseline). Two of the remaining subjects were willing to be tested on a different day. Six out of 9 CR subjects maintained a 4 cm/sec or more improvement in normal walking velocity over baseline compared to 3 out of the 9 controls. Absolute differences were not significant. CR subjects still showed better improvement in WWT velocity at 5 months (3 months post-intervention) compared to baseline (mean change 12.1 cm/sec on WWT velocity) than the control subjects (mean change 4.3 cm/sec).

The experiment showed transfer of gains from CR to untrained domains such as walking, walking while talking, and attention functions. CR had a larger effect on the primary outcome of WWT, a real world task with higher attention demands than normal walking. Despite the small numbers and baseline gait differences among groups, the 3 month post-intervention exploratory results support sustained effects of CR.

There were no adverse events related to the interventions. The experiment had an attrition rate of 17%. CR subjects on exit interviews reported enjoying the training despite being frail and computer novices. They agreed that the length of the CR training and schedule were reasonable. The control subjects appreciated receiving the brochures, the fitness awareness workshop, and the list of local health facilities—but did not report increasing their physical activity levels at the end of the study.

While the foregoing invention has been described in some detail for purposes of clarity and understanding, it will be appreciated by one skilled in the art, from a reading of the disclosure, that various changes in form and detail can be made without departing from the true scope of the invention in the appended claims.

### REFERENCES

1. Judge J O et al. Exercise to improve gait velocity in older persons. Arch Phys Med Rehabil 74: 400-406, 1993.
2. Eyigor S et al. Effects of a group-based exercise program on the physical performance, muscle strength and quality of life in older women. Arch Gerontol Geriatr 45: 259-271, 2007.
3. Schlicht J et al. Effect of intense strength training on standing balance, walking speed, and sit-to-stand performance in older adults. J Gerontol A Biol Sci Med Sci 56: M281-286, 2001.
4. Puggaard L et al. Effects of training on functional performance in 65, 75 and 85 year-old women: experiences deriving from community based studies in Odense, Denmark. Scand J Med Sci Sports 13: 70-76, 2003.
5. Fiatarone M A et al., Exercise training and nutritional supplementation for physical frailty in very elderly people. N Engl J Med 330: 1769-1775, 1994.
6. Lord SR et al. The effect of exercise on gait patterns in older women: a randomized controlled trial. J Gerontol A Biol Sci Med Sci 51: M64-70, 1996.
7. Timonen L et al., A randomized controlled trial of rehabilitation after hospitalization in frail older women: effects on strength, balance and mobility. Scand J Med Sci Sports 12: 186-192, 2002.
8. Posner M I. Orienting of attention. Q J Exp Psychol 32:3-25, 1980.
9. Singh M A. Exercise comes of age: rationale and recommendations for a geriatric exercise prescription. J Gerontol A Biol Sci Med Sci 57: M262-282, 2002.
10. Prohaska TR et al. Sources of attrition in a church-based exercise program for older African-Americans. Am J Health Promot 14: 380-385, 2000.
11. Jancey J et al. Effective recruitment and retention of older adults in physical activity research: PALS study. Am J Health Behav 30: 626-635, 2006.
12. Johnson JK et al., Executive function, more than global cognition, predicts functional decline and mortality in elderly women. J Gerontol A Biol Sci Med Sci 62: 1134-1141, 2007.
13. Holtzer R et al. Cognitive processes related to gait velocity: results from the Einstein Aging Study. Neuropsychology 20: 215-223, 2006.
14. Holtzer R et al, The relationship between specific cognitive functions and falls in aging. Neuropsychology 21: 540-548, 2007.
15. Haimov I et al., Chronic insomnia and cognitive functioning among older adults. Behav Sleep Med 6:32-54, 2008.
16. Smith J M et al., Inosine promotes recovery of skilled motor function in a model of focal brain injury. Brain 130: 915-925, 2007.
17. Willis S L et al. Long-term effects of cognitive training on everyday functional outcomes in older adults. JAMA 296: 2805-14, 2006.
18. Yang Y R et al. Dual-task exercise improves walking ability in chronic stroke: a randomized controlled trial. Arch Phys Med Rehabil 88: 1236-40, 2007.
19. Ada L et al., A treadmill and overground walking program improves walking in persons residing in the community after stroke: a placebo-controlled, randomized trial. Arch Phys Med Rehabil 84: 1486-91, 2003.
20. Baezner H et al. Amantadine increases gait steadiness in frontal gait disorder due to subcortical vascular encephalopathy: a double-blind randomized placebo-controlled trial based on quantitative gait analysis. Cerebrovasc Dis 11: 235-244, 2001.
21. Ben-Itzhak R et al., Can methylphenidate reduce fall risk in community-living older adults? A double-blind, single-dose cross-over study. J Am Geriatr Soc 56: 695-700, 2008.
22. Auriel E et al. Effects of methylphenidate on cognitive function and gait in patients with Parkinson's disease: a pilot study. Clin Neuropharmacol 29: 15-17, 2006.
23. Devos D et al. Improvement of gait by chronic, high doses of methylphenidate in patients with advanced Parkinson's disease. J Neurol Neurosurg Psychiatry 78: 470-475, 2007.
24. Meyers C A et al. Methylphenidate therapy improves cognition, mood, and function of brain tumor patients. J Clin Oncol 16: 2522-2527, 1998.
25. Ball K et al. Effects of cognitive training interventions with older adults: a randomized controlled trial. JAMA 288: 2271-81, 2002.
26. Edwards J D et al., The impact of speed of processing training on cognitive and everyday performance. Aging Ment Health 9: 262-71, 2005.
27. Bherer L et al. Transfer effects in task-set cost and dual-task cost after dual-task training in older and younger adults: further evidence for cognitive plasticity in attentional control in late adulthood. Exp Aging Res 34: 188-219, 2008.
28. Erickson KI et al. Training-induced plasticity in older adults: effects of training on hemispheric asymmetry. Neurobiol Aging 28: 272-283, 2007.
29. Wadley V G et al., Development and evaluation of home-based speed-of-processing training for older adults. Arch Phys Med Rehabil 87:757-763, 2006.
30. Vance D et al. The Accelerate Study: The longitudinal effect of speed of processing training on cognitive performance of older adults. Rehabilitation Psychology 52: 89-96, 2007.
31. Roenker D L et al., Speed-of-processing and driving simulator training result in improved driving performance. Hum Factors 45: 218-233, 2003.
32. O'Connor K P et al., Cognitive-behaviour therapy and skilled motor performance in adults with chronic tic disorder. Neuropsychol Rehabil 18: 45-64, 2008.
33. Mahncke H W et al., Memory enhancement in healthy older adults using a brain plasticity-based training program: a randomized, controlled study. Proc Natl Acad Sci USA 103: 125-23-12528, 2006.
34. Craik F I et al. Cognitive rehabilitation in the elderly: effects on memory. J Int Neuropsychol Soc 13: 132-142, 2007.
35. Basak C et al., Can training in a real-time strategy video game attenuate cognitive decline in older adults? Psychol Aging 23: 765-777, 2008.
36. Verghese J et al., Validity of divided attention tasks in predicting falls in older individuals: a preliminary study. J American Geriatrics Society 50: 1572-6, 2002.
37. McKinley P et al., Effect of a community-based Argentine tango dance program on functional balance and confidence in older adults. J Aging Phys Act 16: 435-453, 2008.
38. Posner M I et al. The attention system of the human brain. Annu Rev Neurosci 13:25-42, 1990.
39. Fan J et al. The activation of attentional networks. Neuroimage 26:471-479, 2005.
40. Fan J et al. Testing the efficiency and independence of attentional networks. J Cogn Neurosci 14:340-347, 2002.
41. Konrad et al., Development of attentional networks: an fMRI study with children and adults. Neuroimage 28:429-439, 2005.
42. Fan J et al. Mapping the genetic variation of executive attention onto brain activity. Proc Natl Acad Sci USA 100:7406-7411, 2003.
43. Fossella J et al., Assessing the molecular genetics of attention networks. BMC Neuroscience 3:14, 2002.
44. Yogev G et al. The role of executive function and attention in gait. Mov Disord. 23(3):329-42, 2008.
45. U.S. Pat. No. 6,632,174, issued Oct. 14, 2003, Breznitz.

What is claimed is:

1. A method of improving motor function of a subject, comprising administering cognitive function training to the subject in an amount and manner effective to improve mobility in the subject.

2. The method of claim 1, wherein the cognitive function training is executive function training.

3. The method of claim 1, wherein the cognitive function training is attention training.

4. The method of claim 1, wherein the cognitive functions trained are executive function and attention training.

5. The method of claim 1, wherein motor function of the subject is assessed prior to cognitive function training.

6. The method of claim 5, wherein motor function of the subject is assessed following cognitive function training, and compared to motor function prior to cognitive function training to assess the improvement in motor function.

7. The method of claim 1, wherein the motor function improved is gait.

8. The method of claim 1, wherein the motor function improved is walking speed.

9. The method of claim 1, wherein the motor function improved is speed of walking while talking.

10. The method of claim 1, wherein the motor function improved is reduced incidence of falling.

11. The method of claim 1, wherein the cognitive training is undertaken three or more times weekly.

12. The method of claim 11, wherein the cognitive training is undertaken for about 40 minutes each day.

13. The method of claim 12, wherein the cognitive training includes about 20 minutes of executive function training and about 20 minutes of attention function training.

14. The method of claim 11, wherein the training is undertaken for 8 or more weeks.

15. The method claim 1, wherein the cognitive training is computer based training.

16. The method of claim 15, wherein the computer based training incorporates game theory.

17. The method of claim 15, wherein the computer based training has size and color adaptations that take into account sensory capacities of older adults.

18. The method of claim 1, wherein the cognitive training is undertaken at home by the subject.

19. The method of claim 1, wherein the subject is 65 years of age or older.

20. The method of claim 1, wherein, the subject is 70 years of age or older.

21. The method of claim 1, wherein the subject has a motor function disability before the onset of cognitive training.
